(19) United States
(12) Patent Application Publication
(10) Pub. No.: US 2016/0340762 A1
(43) Pub. Date: Nov. 24, 2016

(54) Cladding Composition and Method for Remanufacturing Components

(71) Applicant: Caterpillar Inc., Peoria, IL (US)

(72) Inventors: Daniel T. Cavanaugh, Chillicothe, IL (US); Justin Embrey, Morton, IL (US); Waylon S. Walker, Peoria, IL (US)

(73) Assignee: CATERPILLAR INC., Peoria, IL (US)

(21) Appl. No.: 14/717,779

(22) Filed: May 20, 2015

(51) Int. Cl. C22C 38/52; C22C 38/44; C22C 38/42; C22C 38/12; C22C 38/10; C23C 30/00; C22C 38/04; C22C 38/02; C22C 38/00; B23K 26/34; C23C 26/00; C22C 38/46; C22C 38/08

(52) U.S. Cl. CPC C22C 38/52; C22C 38/46; C22C 38/44; C22C 38/42; C22C 38/12; C22C 38/105; C22C 38/08; C22C 38/04; C22C 38/02; C22C 38/001; B23K 26/34; C23C 26/00; C23C 30/005

(57) ABSTRACT

A cladding composition is configured for use in a laser cladding process to remanufacture the wear surfaces of machine components that require a significant degree of hardness. The cladding composition can be provided in a powdered form and can include molybdenum (Mo), tungsten (W), cobalt (Co), nickel (Ni), carbon (C), and manganese (Mn) with the balance of the composition being iron. The cladding composition, after melting and solidifying on the wear surface, can from a solid cladding layer having a hardness of 50 or greater as measured on the Rockwell C scale while maintain a significant degree of fracture toughness.

### TECHNICAL FIELD

This patent disclosure relates generally to powdered compositions for use in laser cladding processes and, more particularly, to the use of such compositions and processes to remanufacture the wear surfaces of machine components.

### BACKGROUND

Many parts and components utilized in mechanical machines, such as internal combustion engines and the like, have wear surfaces in moving or static contact with other components of the machine. Two examples of such components are camshafts and crankshafts that have lobes, pins, and journals that make contact with other components of the engine for transferring power and inducing motion. The wear surfaces of these components are subjected to structural and mechanical loads and friction due to the relative motion of the components. Because of these forces, the components are typically made from hard, strong materials such as alloyed steels and other metals. To further improve strength of the component, the wear surfaces may be subjected to additional hardening processes that increase the hardness of the material proximate the wear surfaces.

However, over prolonged time and use, the applied loads and wear may still damage the wear surfaces of the components, for example, by developing cracks and fissures. To avoid having to discard or scrape such expensive components, one may attempt to remanufacture the components by reconditioning the wear surfaces. Grinding down the wear surfaces to remove cracks is one example of remanufacturing but grinding may reduce the original dimensions of the component and may be difficult to achieve due to the odd or complex shape of the components. Other examples of remanufacturing include additive processes that involve welding or bonding additional material to the wear surface to maintain the original dimensions. Additive processes generally require precise controls to preserve dimensions and are complicated by the requirement of bonding or joining the different materials.

U.S. Patent Publication No. 2014/0287165 (“the '165 publication”), assigned to Caterpillar Inc. of Peoria, Ill., describes laser cladding which is an example of an additive manufacturing process for coating surfaces of metal components. In laser cladding, a cladding composition that may be in powdered form, often containing metal particles, is introduced proximate to a surface of a substrate where the powdered composition is melted by a laser beam from a laser head that may have been redirected or refocused to impinge on the surface. The melted composition cools and hardens on the surface to form a finished cladding layer. Despite its versatility, the '165 publication notes the laser cladding process may have unintended effects that leave the finished cladding layer susceptible to additional cracking or fracturing due to the formation of fracture lines or pores in the cladding material during the process. The present disclosure is directed to reducing or eliminating these negative effects.

### SUMMARY

In one aspect of the disclosure, a cladding composition in powdered form is provided for resurfacing steel alloy components via a laser cladding process. The cladding composition can include, as measured by weight percent, molybdenum (Mo) from about 5% to about 8%, tungsten (W) from about 2.5% to about 5.5%, cobalt (Co) from about 1.5% to about 2%, nickel (Ni) from about 1% to about 2%, carbon (C) from about 0.6% to about 0.8%, and manganese (Mn) from about 0.1% to about 0.75%. The balance of the cladding composition can be substantially iron.

In another aspect, the disclosure provides a remanufactured component made from an original substrate of a steel-based alloy having a wear surface formed thereon and a laser cladding composition subsequently bonded to the wear surface of the original substrate to form a solid cladding layer. The laser cladding composition can by weight percentage: about 5% to about 8% molybdenum (Mo), about 2.5% to about 5.5% tungsten (W), about 1.5% to about 2% cobalt (Co), about 0.6% to about 0.8% carbon (C), and about 0.02% to about 0.05% manganese (Mn) with the balance of the composition being substantially iron.

In yet another aspect of the disclosure, there is described a method for remanufacturing a machine component having a work surface. The method includes grinding down the work surface to remove a hardened layer and to expose a softer base surface below the hardened layer. The method further involved introducing a cladding composition in powdered form proximate the softer base surface. The cladding composition can include, by weight percentage, between about 5%-8% molybdenum (Mo), between about 2.5%-5.5% tungsten (W), between about 1.5%-2% cobalt (Co), about 0.6%-0.8% carbon (C), and about 0.02%-0.05% manganese (Mn) with the balance of the composition being substantially iron. The cladding composition is melted with a laser so that the cladding composition as melted becomes deposited adjacent to the softer base surface. The cladding composition as melted is allowed to solidify and a form a solid cladding layer bonded to the softer base surface which has a hardness of 50 Rockwell C scale or greater.

### BRIEF DESCRIPTION OF THE DRAWINGS

FIG. 1 is a schematic illustration of a laser cladding process for remanufacturing the wear surfaces of machine components using a powdered cladding composition.

FIG. 2 is a detailed view of the laser cladding process of FIG. 1 illustrating possible stresses and fracture lines that may form in the solid cladding layer as deposited on the wear surfaces of the machine component.

FIG. 3 is a microscopic image of a solid cladding layer in accordance with the disclosure as bonded to a machine component by a laser cladding process and illustrating the microstructure thereof.

FIG. 4 is a microscopic image of a solid cladding layer in accordance with the disclosure after a cryogenic treatment process to increase the hardness thereof.

FIG. 5 is a schematic representation in the form of a flow chart illustrating a process for remanufacturing a machine component using a laser cladding process and the disclosed cladding composition.

### DETAILED DESCRIPTION

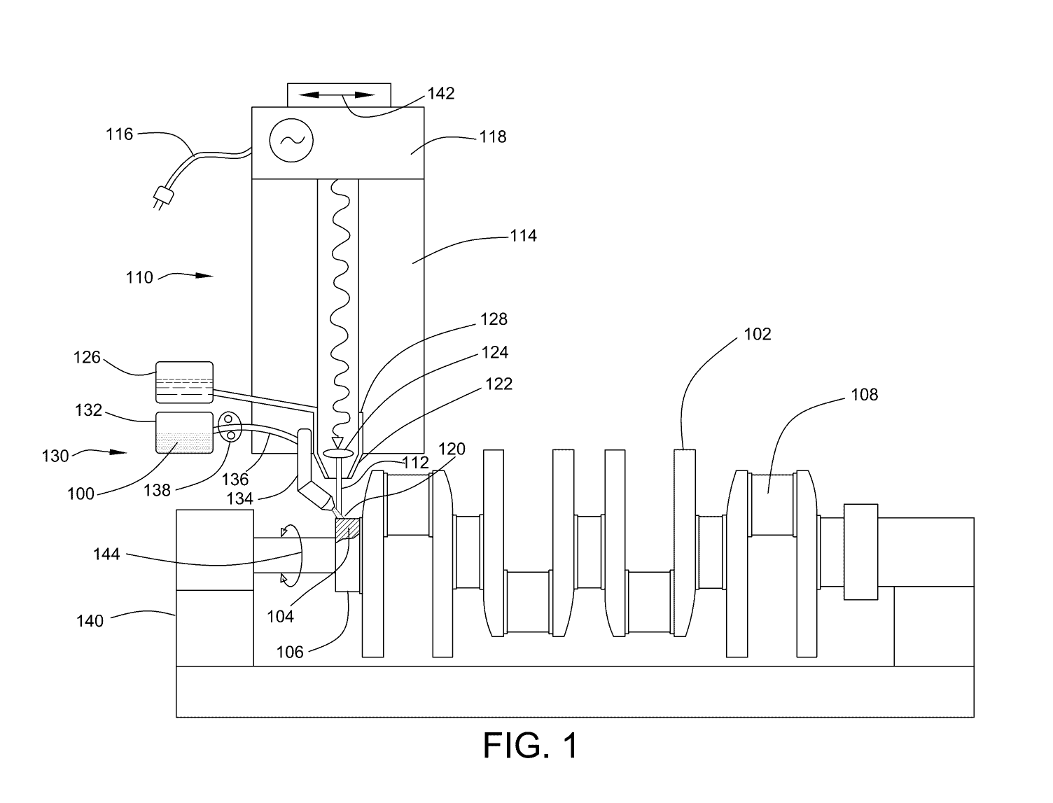

This disclosure relates to materials, compositions and methods for remanufacturing machine components via a laser cladding process. Referring to FIG. 1, wherein like reference numbers refer to like features, there is illustrated an exemplary laser cladding process for depositing a laser cladding composition 100, initially provided in powdered form, onto the wear surface 104 of a machine component 102 which, in the illustrated embodiment, may be an elongated crankshaft of an internal combustion engine. Because of the high stresses and loads encountered in their intended applications, the machine components 102 may be made from high-strength, metallic materials such as carbon steel alloys like tool steels. Furthermore, the wear surfaces of the machine component may have undergone surface hardening treatments to increase the hardness of the component.

The wear surface 104 may be located on a bearing journal 106 of the machine component 102 disposed at the axial ends of the component and which are cylindrical in shape. When the machine component 102 is disposed in an operating internal combustion engine, the wear surfaces 104 make rotating contact with the bearing blocks that support the crankshaft. It will be appreciated that in its intended environment, the wear surface 104 is subjected to significant structural and mechanical loads and applied frictional forces such that, over time, the wear surface may become damaged by, for example, cracking, pitting, and fatigue. To avoid scrapping the machine component 102, the laser cladding process and the disclosed laser cladding composition 100 are used to recondition the wear surface 104. It will be noted that in other embodiments, the wear surfaces at issue may be located at other locations on the machine component 102, such as the crankpins 108, or that the machine component may be different from a crankshaft such as, for example, a camshaft.

To conduct the laser cladding process according to the disclosure, any suitable laser cladding apparatus 110 can be utilized. As will be appreciated by those of skill in the art, a laser cladding apparatus 110 generates and directs a laser beam 112 to impinge on a substrate where the energy of the laser melts a cladding composition to form a cladding layer deposited over the substrate. In the illustrated embodiment, to generate the laser beam 112, the laser cladding apparatus 110 can include a laser head 114 in which a power source 116 supplies power to a laser generator 118 that can emit a coherent beam of light or laser. The laser generator 118 can operate using any suitable amplification medium, for example, a gas-based medium, a crystal-based medium, or diode-based medium, and can generate laser beams 112 of any suitable wavelengths for use in cladding processes. Moreover, the laser generator 118 can generate any level of output power suitable for use in laser cladding processes, for example, on the order of one to several kilowatts.

The laser beam 112 can exit the laser head 114 through a laser outlet 122 and can be directed toward a focus point 120 on the work surface through a laser outlet 122 disposed proximate to the work surface of the component 102. To focus the laser beam 112 into the focus point 120, the laser head 114 may include one or more lens 124 or other optics disposed within the path of the laser beam 112. In various embodiments, to facilitate the ability of the laser beam 112 to melt the cladding composition 100 and subsequent solidification of the composition, the laser head 114 can be configured to introduce a solid or gaseous flux from a flux source 126 to a position proximate the focus point 120 of the laser beam. For example, the laser head may 114 include flux channels 128 in communication with the flux source 126 and that are disposed in the laser head and through the laser outlet 122 directed toward the focus point 120 of the laser beam 112.

To direct the cladding composition 100 proximate to the focus point 120 of the laser beam 112, the laser cladding apparatus 110 can include a material feed system 130. In the present embodiment, where the laser cladding composition 100 is initially in powdered form, the material feed system 130 can include a refillable reservoir 132 to hold the powdered composition and which is in communication with a nozzle 134 disposed on or in the laser head 114 proximate the laser outlet 122. To transfer the laser cladding composition from the reservoir 132 to the nozzle 134, the material feed system 130 can also include hoses 136 and a selectively adjustable feeder pump 138 or similar device that can deliver selective amounts of the composition to the nozzle 134, for instance, via air pressure. The discharge orifice of the nozzle 134 can be directed at an angle toward the wear surface 104 of the machine component 102 where the focus point 120 of the laser beam 112 is intended to impinge so that the nozzle does not otherwise obstruct the path of the laser beam. In various embodiments, the cladding composition 100 in powdered form can be deposited on the wear surface 104 prior to composition and work surface being exposed to the focus point 120 of the laser beam 112 or the composition may be introduced directly into the focus point.

To support the machine component 102 during the cladding operation, the laser cladding apparatus 110 can include a fixture 140 that holds the component relative to the laser head 114. The fixture 140 can be configured to move the machine component 102 and laser head 114 relative to each other so that the laser beam 112 and its focus point 120 can traverse or move about the wear surface 104 for increased coverage. For example, the laser head 114 may be configured to move in a lateral direction 142 (indicated by arrow) and the fixture 140 can rotate the component in a rotational direction 144 (indicated by arrow) so that the laser beam 112 can cover the entire wear surface 104 of the cylindrical bearing journal 106. In other embodiments, the fixture 140 can be configured to move the machine component 102 and the laser head 114 in additional or other directions including, for example, in a six degree-of-freedom configuration. Moreover, the fixture 140 can be operatively associated with a computer-aided design (CAD) system to control and guide the relative motion of the machine component 102 and laser head 114.

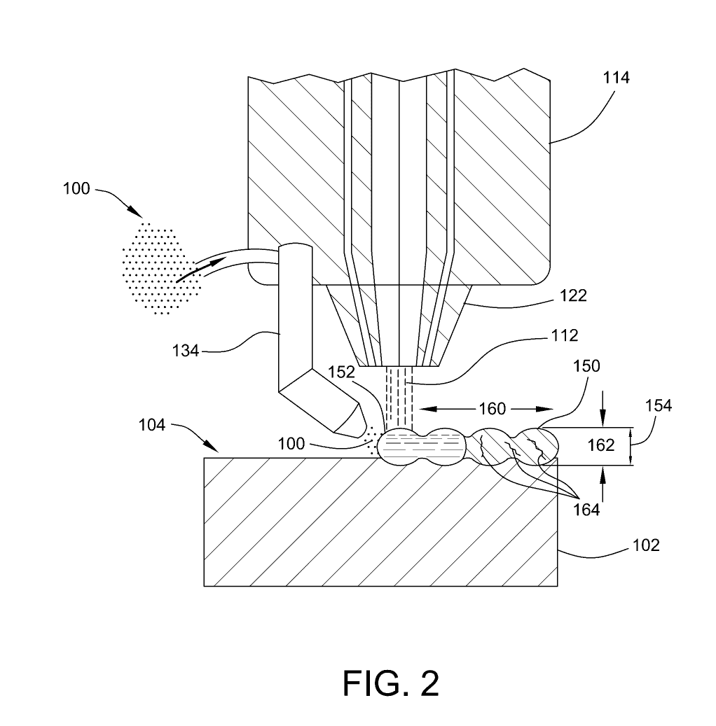

Referring to FIG. 2, there is illustrated a detailed view of the laser cladding process to deposit and convert the cladding composition 100 in powdered form into a solid cladding layer 150 of rigid, solid material over the wear surface 104 of the machine component 102. In the embodiment illustrated, the nozzle 134 introduces the cladding composition 100 in powdered form proximate the focus point 120 of the laser beam 112 on the wear surface 104. The energy of the laser beam 112 can be sufficient to increase the temperature at the focus point 120 and melt the cladding composition 100 to convert the composition from a powder to a liquid melt pool 152 on the wear surface 104. The flowing, liquid state of the melt pool 152 may assist distribution of the cladding composition 100 over at least a portion of the wear surface 104.

As the laser head 114 and the machine component 102 move with respect to each other, the melt pool 152 moves away from the focus point 120 of the laser beam 112 so that the melt pool may cool and harden into a solid. The hardened melt pool 152 therefore forms the solid cladding layer 150. The solid cladding layer 150 may have physical or chemical properties different from the material of the machine component 102 underneath, such as increased hardness or corrosion resistance. The nozzle 134 and the rest of the material feed system may be configured to adjust the quantity of the cladding composition 100 deposited to further control the cladding thickness 154 (indicated by arrow) of the resulting solid cladding layer 150, which may be on the order of 100 microns or greater to one or more millimeters thick. By way of example, the cladding thickness 154 may be on the order of 0.3-0.5 millimeters (mm) and, in various embodiments, a plurality of successive layers can be added over each other to build up the solid cladding layer.

The melting of the cladding composition 100 from a powdered form into the melt pool 152 and the subsequent cooling and solidification into the solid cladding layer 150 may occur relatively quickly. For example, depending upon the quantities and thickness of the cladding composition 100 being deposited and the energy of the laser beam 112, the melt pool 152 may be raised to a temperature in excess of 1500° C. or greater then cooled to a solidification temperature in 2 seconds or less. The rapid thermal expansion and contraction the cladding composition 100 undergoes during the cooling and solidification process, i.e. the thermal shock, may result in or impart residual stress in the solid cladding layer 150.

For example, the contraction of the individual beads 156 of the solid cladding layer 150 may result in lateral strains 160 (indicated by arrow) laterally across the machine component 102 and parallel to the wear surface 104. In addition, cooling of the solid cladding layer 150 may result in thickness stresses 162 (indicated by arrow) as the cladding composition 100 attempts contract in direction of the cladding thickness 154. The effect of the lateral strain 160 and the thickness stresses 162, and possibly other resulting stresses, is that fracture lines 164 may begin to form with the solid cladding layer 150 as the composition tends to separate from itself and apart from the wear surface 104. The fracture lines may also propagate into the wear surface of the component. The fracture lines 164 may microscopic on scale but may adversely affect the usefulness of the solid cladding layer 150 in the intended application of the machine component 102 being remanufactured. In particular, the fracture lines 164 may result in brittleness of the solid cladding layer 150 so that it forms larger cracks propagating through the layer that may ultimately result in the layer breaking apart and failing under relatively light loads.

To prevent the formation of fracture lines 164, the cladding composition 100 may be composed of constituent components suited for the laser cladding process. In an embodiment, the cladding composition may include an iron (Fe) base with carbon (C) and varying amounts of molybdenum (Mo), tungsten (W), chromium (Cr), and vanadium (V). In a further embodiment, the cladding composition 100 may additionally include one or more of the following: cobalt (Co), nickel (Ni), and silicon (Si). In another embodiment, the cladding composition 100 may include copper (Cu) and manganese (Mn). The quantities of the constituent components may be present in amounts relative to each other to promote fracture resistance in the finished solid cladding layer. For example, in an embodiment the constituents may be present in amounts by weight percentage of about 1% or less of carbon (C), about 5-9% molybdenum (Mo), about 2.5-5.5% tungsten (W), about 1-4% chromium (Cr), and about 1-4% vanadium (V). In a further embodiment, the additional constituents may be present in amounts by weight percentage of about 1.5-2% cobalt (Co), about 1-2% nickel (Ni), and 0.1-1% silicon (Si). In another further embodiment, the additional constituents may be present in amounts by weight percent of about 0-0.1% copper (Cu) and about 0.2-0.75% manganese (Mn).

In a more particular embodiment, the cladding composition can include the constituents present in amounts by weight percent of about 0.6-0.8% carbon (C), about 6-7% molybdenum (Mo), about 3.5-4.5% tungsten (W), about 1-2% chromium (Cr), and about 1-2% vanadium (V). Further, the additional constituents may be present in amounts by weight percentage of about 1.5-2% cobalt (Co), about 1-2% nickel (Ni), and 0.1-1% silicon (Si). Further yet, the other additional constituents may be present in amounts by weight percentage of about 0.02-0.05% copper (Cu) and 0.2-0.5% manganese (Mn). In addition, any of the foregoing cladding compositions may include trace amounts of impurity elements such as sulfur (S), phosphorus (P), nitrogen (N), and oxygen (O).

Without being limited by theoretical explanation, it is believed the recited constituents may provide various characteristics that facilitate the transition from the powdered form of the cladding composition 100 to the liquid melt pool 152 to the solid cladding layer during the laser cladding process. For example, it is believed that molybdenum may help provide toughness and fracture resistance to the solid cladding layer. It is also believed that cobalt, nickel, and silicon assist in providing toughness and fracture resistance. It is believed that constituents like vanadium, tungsten, and chromium may help provide hardness and strength to the solid cladding layer. The laser cladding process produces a metallurgical bond between the solid layer cladding and the wear surface of the base component, possibly characterized by physical and chemical bonding at the interface and which is substantially free of voids or discontinuities. Additionally, as the constituents melt and mix together, they may form microstructures that provide the solid cladding layer with characteristics that facilitate its use on the remanufactured machine component.

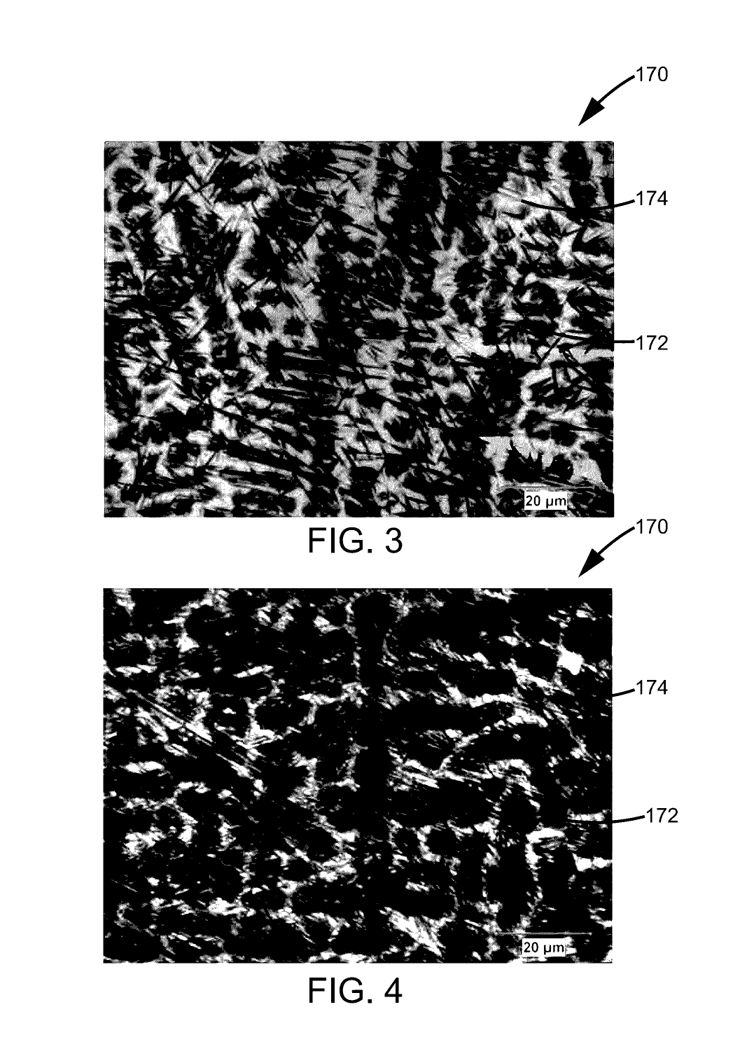

For example, referring to FIG. 3, there is illustrated a magnified image of the solid cladding layer made from a cladding composition having constituent materials within the ranges described above after the composition has undergoing melting and subsequent solidification via the laser cladding apparatus. Because the laser cladding process rapidly melts the cladding composition in powdered form and allows the melt pool to quickly cool to form the solid cladding layer, the solidifying melt pool may form a microstructure 170 that can include a material referred to as martensite 172, represented by the darker, black areas of FIG. 3, suspended within another material referred to as retained austenite 174, represented by the lighter, grey areas. Martensite is a form of carbon steel in which carbon atoms are supersaturated in the resulting iron crystal structure of the solid that is obtained by rapidly cooling a solution including iron and carbon that are initially present an austenite phase. The rapid cooling prevents carbon from precipitating from the solution so that the resulting alloyed microstructure retains and is saturated with carbon atoms that would be suspended in but distinct from the alloy.

Martensite is typically characterized by its hardness, strength, and brittleness. It is believed that the presence of martensite provides the solid cladding layer with the hardness desired for the remanufactured machine component. The presence of martensite may also result in a phenomenon referred to as transformation toughening in which the physical changes associated with transformation from one phase to another phase prevent further crack or fracture propagation. The retained austenite 174 may also provide some relative ductility to prevent crack formation. The combination of martensite and retained austenite in particular proportions is believed to prevent or reduce stresses that could otherwise result in fracture and cracks forming during solidification and cooling of the melted cladding composition. By way of example only, the quantity of martensite 172 and of retained austenite 174 may be roughly about 75% to about 90% depending upon component size, laser power, etc.

Referring to FIG. 4, in a further embodiment, the solid cladding layer can be subjected to a post-solidification process to improve further the characteristics of the microstructure 170. For example, while the solid cladding layer is still at an elevated temperature in which the initial martensite 172 and the retained austenite 174 are present, the machine component with the solid cladding layer deposited thereon can be subjected to rapid cooling through the use of a cryogenic application. One result of rapidly cooling the solid cladding layer is that some of the retained austenite 174 may convert to additional martensite 172 within the microstructure 170. The formation of additional martensite 172 further increases the hardness of the solid cladding layer. Moreover, because the cryogenic treatment and resulting formation of additional martensite 172 occurs after the melt pool has solidified and become rigid, it is believed that formation of the lateral and thickness stresses in causing fractures and cracks will be reduced. In particular, it is believed that by increasing hardness of the solid cladding layer, which is related to brittleness, by martensitic formation after the layer has converted to a rigid structure reduces the generation of lateral and thickness stresses. Hence, the solid cladding layer demonstrates a significant degree of hardness but remains substantially crack-free.

### Example 1

The following hypothetical example further illustrates the disclosure but should not be in any way construed as limiting its scope. Several different formulations of cladding compositions were prepared and processed through a laser cladding process as described above and the results compared. The cladding composition determined by the Applicants to provide advantageous characteristics overall suitable for a solid laser cladding useful for remanufacturing a machine component was believed to include the following constituent materials: about 0.6-0.8% carbon (C), about 6-7% molybdenum (Mo), about 3.5-4.5% tungsten (W), about 1-2% chromium (Cr), about 1-2% vanadium (V), about 1.5-2% cobalt (Co), about 1-2% nickel (Ni), 0.1-1% silicon (Si), about 0.02-0.05% copper (Cu), and 0.2-0.5 manganese (Mn). The cladding composition can be formed as a powder by a gas atomization process with an average particle size suitable for use in laser cladding process such as, for example, approximately 50-150 microns (μm). The constituents can be mixed and compounded prior to the atomization process to form particles of alloy or can remain as separate particles of distinct elements in the powder.

For testing, the cladding composition was deposited on a substrate of high alloy steel using a laser cladding apparatus with an output power setting of approximately 4.8-6 kilowatts (kW) and the properties of the resulting solid cladding layer were analyzed. The solid cladding layer had hardness valves of 50 Rockwell C or greater. In particular, the layers had a measured hardness of 56.7 Rockwell C without cryogenic treatment and a measured hardness of 65.8 Rockwell C after cryogenic treatment. In addition, the qualitative properties were analyzed by suitable methods, such as inspections for fracture lines and cracks. These inspections could be conducted visually, microscopically, or by x-ray scans or ultrasound. Notably, no significant formation of fatigue lines and cracks were observed. Additionally, the solid cladding layer was analyzed for other imperfections such as porosity. Although small degrees of porosity were observed, for example, with pore sizes of 0.1 millimeter or less, these were determined to not significantly affect or impact the quality of the solid cladding layer. Formation of pores may also be controlled by adjustment of the laser cladding parameters.

### INDUSTRIAL APPLICABILITY

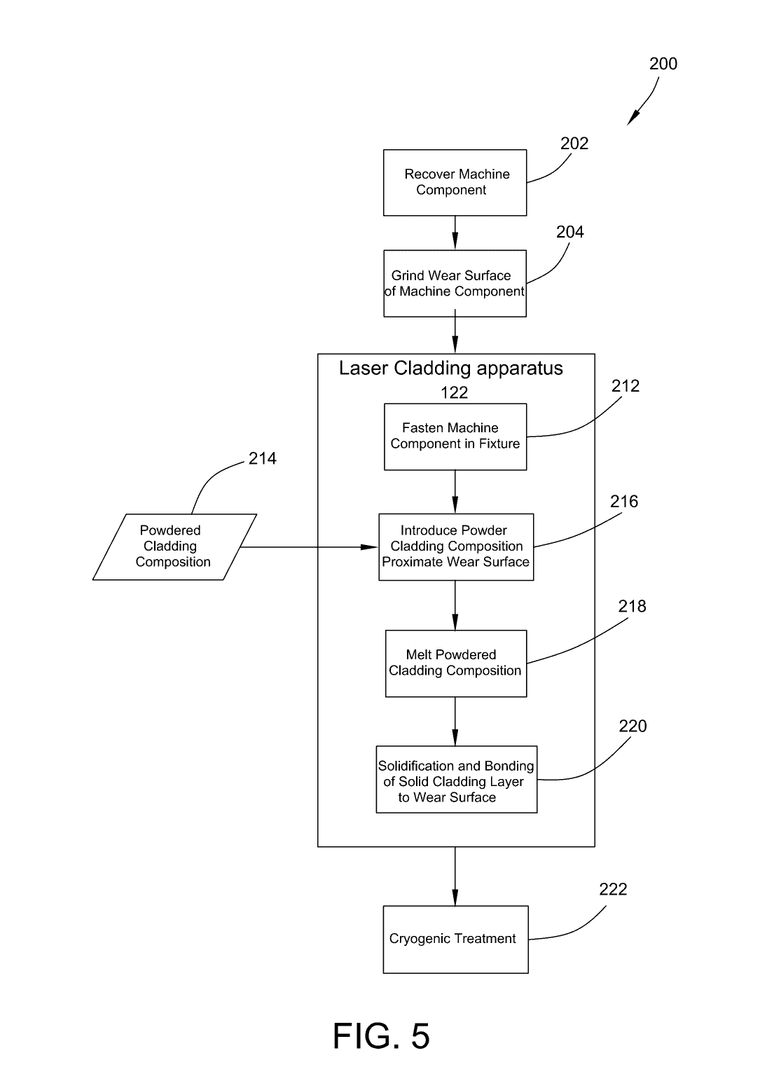

The present disclosure is applicable to remanufacturing a machine component, such as a camshaft or crankshaft, by refurbishing the wear surfaces of the component with a laser cladding composition. Referring to FIG. 5, there is illustrated a remanufacturing process 200 by which remanufacturing of the machine component can be conducted. Such machine components may be made from hard, strong materials such as metals including iron-based materials and steel alloys. As an initial recovery step 202, the machine component is removed from the machine at issue. As indicated above, the wear surfaces of the machine component may have become damaged due to prolonged or excessive loads resulting from the operational application of the machine in its intended environment. If the machine component is in the embodiment of a crankshaft or camshaft, the recovery step 202 may occur during a rebuilding operation of internal combustion engine powering the machine. Because the wear surfaces of the machine component may exhibit damage and may have undergone prior hardening treatments, the remanufacturing process 200 may involve a grinding step 204 in which the hardened but damaged wear surface are removed by grinding. The grinding step 204 also may expose the softer sub-layers of the steel alloy or iron-based component. The softer sub-layers may provide some ductility and softness to accommodate stresses from the cooling and solidification process.

After the machine component has been removed and prepped, the component can be transferred to laser cladding apparatus 210 and, in a fastening step 212, can be secured in a fixture of the laser cladding apparatus. A cladding composition 214 of the disclosed substances in powdered form is also provided. In an introduction step 216, the cladding composition 214 is introduced proximate to the wear surfaces and the laser head of the laser cladding apparatus. In a melting step 218, the laser beam is generated and focused upon the powdered cladding composition 214 to melt the composition over the wear surface. As the fixture arrangement of the laser cladding apparatus moves the machine component and the laser head, initiating the solidification step 220, the melt pool of the formally powdered composition moves away from the laser and can cool and solidify into the rigid solid cladding layer on the wear surface. In various embodiments, the energy of the laser beam may be sufficient so that the solid cladding layer may form a metallurgical bond with the heat-affected layer of the wear surface.

In an embodiment, after the solid cladding layer has formed, the machine component can be subjected to various aftertreatment processes to improve the characteristics of the cladding including, for example, a cryogenic treatment step 222 in which the machine component is rapidly cooled to increase its hardness. Additional tempering or quenching steps and, if necessary, grinding or other machining steps, can be performed on the machine component. An advantage of the foregoing laser cladding process is that the machine component can be remanufactured to have a wear surface of sufficiently high hardness without substantial formation of fracture lines or cracks. Another advantage is that the disclosure provides a laser cladding composition in powdered that can be used in accordance with the disclosed laser cladding process to remanufacture machine components.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A cladding composition in powdered form for resurfacing steel alloy components, the cladding composition consisting essentially of, by weight percent: molybdenum (Mo) from about 5% to about 8%, tungsten (W) from about 2.5% to about 5.5%, cobalt (Co) from about 1.5% to about 2%, nickel (Ni) from about 1% to about 2%, carbon (C) from about 0.6% to about 0.8%, manganese (Mn) from about 0.1% to about 0.75%, silicon (Si) from about 0.1 to about 1%, chromium (Cr) from about 1% to about 2%, vanadium (V) from about 1% to about 2%, and copper (Cu) from about 0% to about 1.0%, a balance of the cladding composition being substantially iron.

2. (canceled)

3. (canceled)

4. The cladding composition of claim 1, wherein the weight percent of molybdenum (Mo) is from about 6% to about 7%.

5. The cladding composition of claim 1, wherein the weight percent of tungsten (W) is about 3.5 to about 4.5%.

6. The cladding composition of claim 1, wherein the weight percent of manganese (Mn) is about 0.2% to about 0.5%.

7. The cladding composition of claim 1, wherein the cladding composition in powdered form has an average particle size is about 50 microns to about 150 microns.

8. The cladding composition of claim 1, wherein the cladding composition in powdered form is formed by a gas-atomization process.

9. The cladding composition of claim 1, further comprising not more than 0.02% of any one of materials selected from the group consisting of S, P, N, and O.

10. A remanufactured machine component comprising:
an original substrate of a steel-based alloy having a wear surface formed thereon,
a cladding composition subsequently bonded to the wear surface of the original substrate to form a solid cladding layer, the clad composition including, by weight percentage: about 5% to about 8% molybdenum (Mo), about 2.5% to about 5.5% tungsten (W), about 1.5% to about 2% cobalt (Co), about 0.02% to about 0.5% manganese (Mn) from and about 0.6% to about 0.8% carbon (C), a balance of the cladding composition being substantially iron.

11. The remanufactured machine component of claim 10, wherein the cladding composition further includes about 1% to about 2% nickel (Ni) and 0.1 to about 1% silicon (Si).

12. The remanufactured machine component of claim 11, where the cladding composition further includes about 1% to about 2% chromium (Cr), about 1% to about 2% vanadium (V), and about 0.02% to about 0.05% Cu.

13. The remanufactured machine component of claim 10, wherein the solid cladding layer demonstrates a hardness of 50 Rockwell C scale or greater.

14. The remanufactured machine component of claim 10, wherein the solid cladding layer has substantially a martensite microstructure.

15. The remanufactured machine component of claim 10, wherein the solid cladding layer has a maximum porosity of about 0.1 millimeter or less.

16. The remanufactured machine component of claim 10, wherein the solid cladding layer forms a metallurgical bond with the original substrate.

17. The remanufactured machine component of claim 10, wherein the original substrate is selected from the group consisting of a camshaft and a crankshaft.

18. A method of remanufacturing a machine component having a wear surface hardened by a previous hardening process, the method comprising the steps of:
grinding down the wear surface to remove a hardened layer and to expose a softer base surface below the hardened layer;
introducing a cladding composition in powdered form proximate the softer base surface, the cladding composition including, by weight percentage, between about 5%-8% molybdenum (Mo), between about 2.5%-5.5% tungsten (W), between about 1.5%-2% cobalt (Co), between about 0.02%-0.05% manganese (Mn), and about 0.6%-0.8% carbon (C), a balance of the cladding composition being substantially iron;
melting the cladding composition with a laser so that the cladding composition as melted is deposited on the softer base surface; and
allowing the cladding composition as melted to solidify and a form a solid cladding layer bonded to the softer base surface;
wherein the solid cladding layer has a hardness of 50 Rockwell C scale or greater.

19. The method of claim 18, wherein the cladding composition in powdered form further includes about 1% to about 2% nickel (Ni), about 0.1 to about 1% silicon (Si), about 1% to about 2% chromium (Cr), about 1% to about 2% vanadium (V), and about 0.02% to about 0.05% Cu.

20. The method of claim 18, wherein the solid cladding layer and the softer base surface of the machine component form a metallurgical bond.
